(19) United States
(12) Patent Application Publication
(10) Pub. No.: US 2013/0051480 A1
(43) Pub. Date: Feb. 28, 2013

(54) De-Blocking Filtering Control

(71) Applicants: Andrey Norkin, Solna (SE); Kenneth Andersson, Galve (SE); Clinton Priddle, Indooroopilly (AU)

(72) Inventors: Andrey Norkin, Solna (SE); Kenneth Andersson, Galve (SE); Clinton Priddle, Indooroopilly (AU)

(73) Assignee: TELEFONAKTIEBOLAGET L M ERICSSON (PUBL), Stockholm (SE)

(21) Appl. No.: 13/695,402

(22) PCT Filed: Feb. 1, 2011
(86) PCT No.: PCT/SE2011/050105

§ 371 Date: Nov. 1, 2012

Related U.S. Application Data
(60) Provisional application No. 61/301,732, filed on Feb. 5, 2010.
(60) Provisional application No. 61/305,005, filed on Feb. 16, 2010.

(30) Foreign Application Priority Data
Dec. 29, 2010 (SE) PCT/SE2010/051494

(51) Int. Cl. H04N 7/26

(52) U.S. Cl. 375/240.29; 375/E07.193

(57) ABSTRACT

A block-specific filter decision value is calculated for a pixel block (10) in a video frame. If the block-specific filter decision value is below a block-specific threshold, each row or column (12) in the block (10) is individually processed in order to select between a strong and a weak de-blocking filter. A respective line-specific filter decision value is thereby calculated for each row or column (12) in the block (10) and compared to a line-specific threshold. If the line-specific filter decision value calculated for a row or column (12) is below the line-specific threshold a strong de-blocking filter is selected for the row or column (12), otherwise a weak de-blocking filter is instead selected to combat any blocking artifacts.

### TECHNICAL FIELD

The present invention generally relates to filtering control and in particular to controlling de-blocking filtering over block boundaries in a video frame.

### BACKGROUND

Encoding of video frames may introduce blocking artifacts to the encoded data. Such blocking artifacts are mainly due to discrete cosine transforms in intra and inter frame prediction error coding. Discontinuities at boundaries between blocks can then become visible to a viewer during reconstruction. Another common source of blocking artifacts is motion compensated prediction.

The traditional approach of combating such blocking artifacts is to use de-blocking filtering. In state of the art video coding, such as H.264, loop filtering with an adaptive de-blocking filter is performed after prediction and residual coding, but before storage of the reconstructed frame for later reference when encoding the following frames, see List et al., Adaptive Deblocking Filter, IEEE Transactions on Circuits and Systems for Video Technology, 2003, 13(7): 614-619. The loop filtering consists of filter decision, filtering operation, clipping function and change of pixel values. The decision to filter the border or not is made based on evaluating several conditions. The filter decision depends on macroblock type, motion vector (MV) difference between neighboring blocks, if one of the neighboring blocks has a coded residual and on the local structure of a current block or the neighboring blocks.

Then the amount of filtering depends on the position of the pixel compared to the block boundary and on the quantization parameter used for residual coding for the current block.

In H.264, a filter decision is made based on pixel values between the block boundary of two neighboring blocks. This applies both to the vertical block boundary and horizontal block boundary. The boundary can be illustrated by pixels a, b, c and d in one block and e, f, g and h in another block where the block boundary is between d and e, see below:

The filter decision is based on comparing three pixel differences with different thresholds. The thresholds are adapted to the quantization parameter (QP). If the following conditions are fulfilled the filter decision is positive |d−e|<T₁, |c−d|<T₂, and |e−f|<T₂, where T₁ and T₂ are adapted based on QP.

There are two filtering modes in H.264. In the first filtering mode (normal filtering), filtering can be described with a delta value (Δ) that the filtering changes the current value. The filtering for the pixels closest to the block boundary is:

d′=d+Δ_{c} and e′=e−Δ_{c}

where Δ_{c} has been clipped off to a threshold ±T₃ and is constrained by the QP. More filtering is allowed for high QP than for low QP. Clipping can be described as:

Δ_{c}=Max(−T₃,Min(T₃,Δ))

The filter strength can be increased if any of the following two conditions also holds |b−d|<T₂ and |e−g|<T₂. The filter strength is also adapted by clipping the delta value less, e.g. to allow for more variation.

The second (strong) filtering mode is only applied for an intra macroblock boundary, when the following condition is fulfilled |d−e|<T₁/4.

A significant limitation with the adaptive de-blocking filter employed in H.264 is that the second, strong filtering mode can only be applied over macroblock edges if at least one of the blocks is an intra block. The calculation of the filter decisions in H.264 is furthermore computational complex since several filter decisions must be verified for each row or column in the block to determine whether de-blocking filtering should be applied or not.

US 2006/0078048 discloses a simplification applicable to de-blocking filtering in H.264 that reduces the computational complexity as compared to standard filtering decisions of H.264. The decision test for conducting normal filtering or no filtering is performed on one row or column or a subset of the rows or columns crossing the boundary between two macroblocks. This decision then applies to all rows or columns crossing the same boundary. As a consequence, a single filtering decision is calculated per macroblock boundary and this single filtering decision applies to all lines crossing the macroblock boundary.

A significant limitation with the adaptive de-blocking filtering disclosed in US 2006/0078048 is that only normal filtering is conducted, which can lead to visible artifacts over block boundaries since stronger filtering is not possible.

### SUMMARY

It is a general objective to provide an efficient de-blocking filtering to combat or reduce blocking artifacts.

This and other objectives are met by embodiments as disclosed herein.

An aspect of the embodiments defines a filtering control method applicable to a block of multiple pixels in a video frame. The method involves calculating a block-specific filter decision value for the block based on pixel values in a predefined subset of the lines of pixels in the block and pixel values in a predefined corresponding subset of corresponding lines of pixels in a neighboring block of multiple pixels in the video frame. This block-specific filter decision value is employed to determine whether any de-blocking filtering should be applied to the current block and over the boundary to the neighboring block or if no de-blocking filtering is needed. If de-blocking filtering should be applied to the current block as determined based on a comparison of the calculated block-specific filter decision value and a block-specific threshold, a respective line-specific filter decision value is calculated for each line of pixels in the block with regard to the boundary. Such a line-specific filter decision value is calculated based on at least one pixel value in the current line and at least one pixel value in a corresponding current line in the neighboring block. The line-specific filter decision value is compared to a line-specific threshold and is employed to determine whether a strong de-blocking filter or a weak de-blocking filter is selected for de-blocking filtering of the current line. The weak de-blocking filter has a comparatively lower filtering strength as compared to the strong de-blocking filter.

Another aspect of the embodiments relates to a filtering control device comprising a block-specific decision value calculator configured to calculate a block-specific filter decision value for a block of multiple pixels in a video frame. The block-specific filter decision value is calculated based on pixel values in a predefined subset of the lines of pixels in the block and pixel values in a predefined corresponding subset of the corresponding lines of pixels in a neighboring block of multiple pixels in the video frame. If the calculated block-specific filter decision value is below a block-specific threshold, a line-specific filter decision value calculator calculates a respective line-specific filter decision value for each line of pixels in the block. The line-specific filter decision value of a line is calculated based on at least one pixel value in the line and at least one pixel value in a corresponding line of pixels in the neighboring block. A threshold comparator is configured to compare the line-specific filter decision value with a line-specific threshold. If the line-specific filter decision value is below the line-specific threshold a filter selector selects a strong de-blocking filter to be applied to the current line, otherwise the filter selector instead selects a weak de-blocking filter.

Further aspects of the embodiments relate to an encoder and a decoder comprising a filtering control device and a media terminal comprising a decoder.

The aspects of the embodiments employ a block-specific filter decision to select whether de-blocking filtering should be applied to a boundary of a current block or not. This means that only a single such filter decision value is needed to make this filtering versus no filtering decision. The block-specific filtering decision is then complemented with respective line-specific decisions for each line in the block to select between strong and weak de-blocking filtering. This leads to a more efficient and better de-blocking filtering.

### BRIEF DESCRIPTION OF THE DRAWINGS

The invention, together with further objects and advantages thereof, may best be understood by making reference to the following description taken together with the accompanying drawings, in which:

FIG. 1 is a drawing schematically illustrating block-wise and line-wise filtering decisions according to an embodiment;

FIG. 2 is a flow diagram illustrating a filtering control method according to an embodiment;

FIGS. 3A and 3B illustrate two embodiments of neighboring blocks and a block boundary over which de-blocking filtering can be applied;

FIG. 4 is a flow diagram illustrating an additional step of the method of FIG. 2 according to an embodiment;

FIG. 5 is a flow diagram illustrating an additional step of the method of FIG. 2 according to an embodiment;

FIG. 6 is a schematic block diagram of an embodiment of a filtering control device;

FIG. 7 illustrates an implementation of a filtering control device according to an embodiment;

FIG. 8 is a schematic block diagram of an encoder according to an embodiment;

FIG. 9 is a schematic block diagram of a decoder according to an embodiment; and

FIG. 10 is a schematic block diagram of a media terminal according to an embodiment.

### DETAILED DESCRIPTION

Throughout the drawings, the same reference numbers are used for similar or corresponding elements.

The embodiments generally relate to adaptive de-blocking filtering or adaptive loop filtering, as it is sometimes denoted, to combat blocking artifacts over block boundaries in a video frame. The embodiments introduce specific filter decisions that are employed to determine whether to apply any de-blocking filtering at all and whether to apply strong filtering or weak filtering to respective pixel lines in the block. The particular filter decisions together with the possibility of using strong or weak filtering enable efficient reduction of blocking artifacts but without an increase in computation complexity.

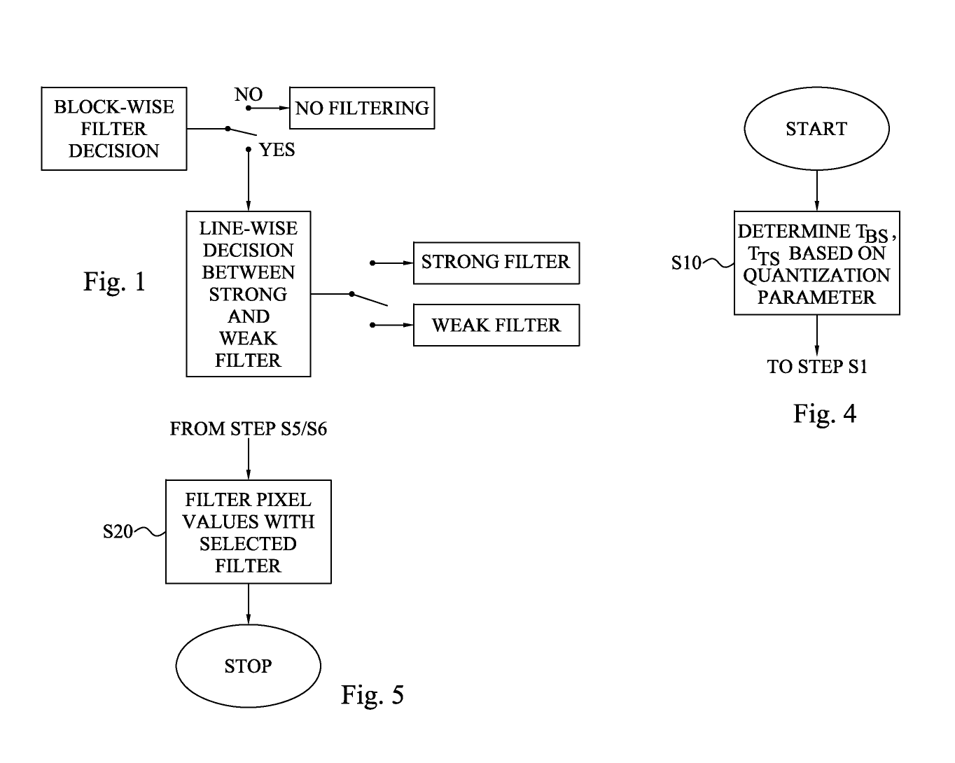

FIG. 1 is a schematic overview of an embodiment of the de-blocking filtering. The embodiment determines two different types of filter decision values for a block of multiple pixels in a video frame. A first filter decision value is a block-specific or block-wise filter decision value that is calculated once for the current block and a current boundary to a neighboring block of multiple pixels in the video frame. This block-specific filter decision value is employed to determine whether any de-blocking filtering should be applied at all to the current block with regard to the boundary to the neighboring block. If it is concluded, based on the block-specific filter decision value, that de-blocking filtering should be applied, the second type of filter decision value is calculated for each line of pixels in the pixel block. The second type of filter decision is, thus, a line-wise or line-specific filter decision employed to select whether strong de-blocking filtering or weak de-blocking filtering should be applied to the current line of pixels in the pixel block. Thus, a block-specific filter decision value is calculated once and applies to all lines in the block with regard to the boundary to the neighboring block. If de-blocking filtering should be applied as determined based on the block-specific filter decision value, a respective line-specific filter decision value is calculated for each line to select between strong and weak de-blocking filtering. This means that it could be possible that strong de-blocking filtering is selected for all lines in the block, weak de-blocking filtering is selected for all lines in the block or some lines will use strong de-blocking filtering whereas other use weak de-blocking filtering.

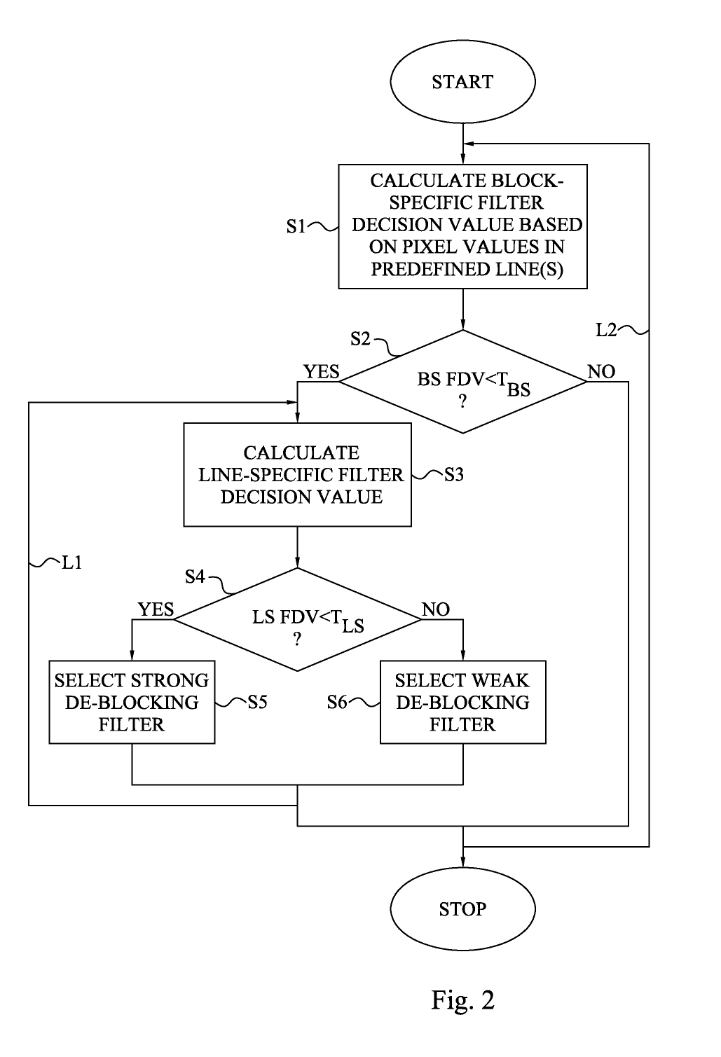

The embodiments will now be described in more detail with reference to FIG. 2, which illustrates a flow diagram of a filtering control method according to en embodiment applicable to a block of multiple pixels in a video frame. As is well-known in the art, a video frame is divided into non-overlapping blocks of pixels that are encoded and decoded according to the various available intra and inter coding modes. Generally, a video frame is divided into non-overlapping macroblocks of 16×16 pixels. Such a macroblock can in turn be divided into smaller blocks of different sizes, such as 4×4 or 8×8 pixels. However, also rectangular blocks could be possible according to the embodiments, such as, 4×8, 8×4, 8×16 or 16×8. The embodiments can be applied to any such block of pixels, including macroblocks or even larger blocks of pixels. In a particular embodiment, the filtering control method is applicable to all blocks of multiple pixels having at least 8 pixels in the vertical direction and/or horizontal direction. In the art, prediction unit partition and transform unit are commonly employed to denote such a block of multiple pixels.

In the emerging High Efficiency Video Coding (HEVC) standard, coding units (CU) are used. The CU size is currently varying from 64×64 pixels (largest) to 4×4 pixels (smallest). In this way, the largest CU can be split into smaller CUs with the “level of granularity” depending on the local characteristics of the frame. That means that the largest CU may be split into smaller CUs of different sizes. The embodiments can also be used in connection with such coding units, which are regarded as being encompassed by the expression “block of pixels” as used herein.

Each pixel in the block has a respective pixel value. Video frames generally have color values assigned to the pixels, where the color values are represented in a defined color formats. One of the common color formats uses one luminance component and two chrominance components for each pixel, although other formats exist, such as using red, green and blue components for each pixel.

Traditionally, luminance component filtering and chrominance component filtering are done separately possibly employing different filtering decisions and different de-blocking filters. The embodiments can be applied to filter the luminance component, filter the chrominance component(s) or filter both the luminance component and the chrominance component(s). In a particular embodiment, the embodiments are applied to achieve luminance or luma filtering.

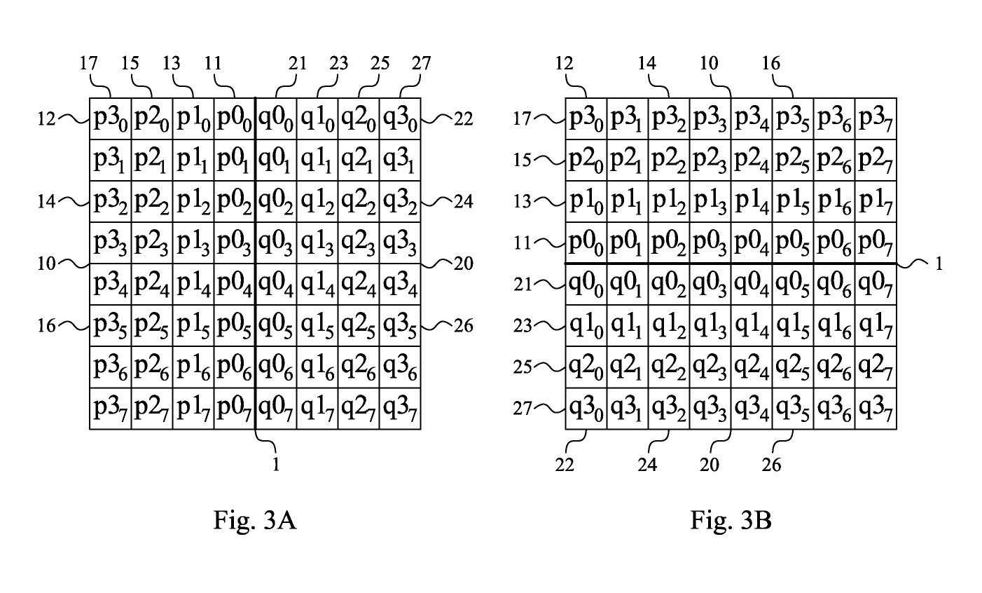

Adaptive de-blocking filtering is conducted over a boundary, edge or border between neighboring blocks. As a consequence, such boundaries can be vertical boundaries 1, see FIG. 3A, between two neighboring blocks 10, 20 present side by side in the video frame. Alternatively, the boundaries are horizontal boundaries 1, see FIG. 3B, between two neighboring block 10, 20, where one block 10 is positioned above the other block 20 in the video frame. In a particular embodiment, vertical boundaries are filtered first starting from the left-most boundary and proceeding through the boundaries towards the right-hand side in their geometrical order. Then, horizontal boundaries are filtered starting with the boundary on the top and proceeding through the boundaries towards the bottom in their geometrical order. The embodiments are, however, not limited to this particular filtering order and can actually be applied to any predefined filtering order. In a particular embodiment, the boundaries at the edge of the video frame are preferably not filtered and thereby excluded from the de-blocking filtering.

The method of this embodiment starts in step S1 where a block-specific filter decision value is calculated for the block. The block-specific filter decision value is calculated based on pixel values in a predefined subset of the lines of pixels in the block and based on pixel values in a predefined corresponding subset of corresponding lines of pixels in the neighboring block. A line of pixels in the current block and the corresponding line of pixels in the neighboring block belong to the same horizontal line, i.e. row, extending over a vertical boundary or belong to the same vertical line, i.e. column, extending over a horizontal boundary.

The predefined subset and the predefined corresponding subset each comprise at least one line at a predefined position in the block and the neighboring block, respectively. For instance, if the block-specific filter decision value is calculated based on pixel values in a predefined line in the block and a corresponding predefined line in the neighboring block the predefined lines have a defined row number or column number. For instance, the predefined line could correspond to row number j or column number j in the block and the corresponding predefined line would then be row number j or column number j in the neighboring block. This then means that the predefined line of another block to be subsequently filtered would also correspond to row number j or column number j in that another block.

Correspondingly, if the block-specific filter decision value is calculated based on pixel values in multiple predefined lines of pixels and multiple corresponding predefined lines of pixels, the predefined lines could be row numbers j, j+k or column numbers j, j+k, where k is a defined positive integer.

According to the embodiments, the block-specific filter decision value is calculated based on pixel values in the predefined subset of the lines in the block and pixel values in the predefined corresponding subset of corresponding lines in the neighboring block. This means that if the block and neighboring block, for instance, comprises eight row or columns not all of these eight rows or columns are employed in the calculation of the block-specific filter decision value but rather a subset thereof. In particular embodiments, the predefined subset comprises a single predefined line of pixels or a first predefined line of pixels and a second predefined line of pixels. The corresponding set of corresponding lines then comprises a single corresponding predefined line of pixels or a corresponding first predefined line of pixels and a corresponding second predefined line of pixels. The block-specific filter decision value is then calculated based on the pixel value of at least one, preferably multiple pixels in the predefined line(s) of pixels the pixel value of at least one, preferably multiple pixels in the corresponding predefined line(s) of pixels.

A next step S2 compares the block-specific filter decision value (BS FDV) with a block-specific threshold (T_{BS}). If the block-specific filter decision value is below the block-specific threshold, the method continues to step S3. However, if the block-specific filter decision value is not below the block-specific decision value no de-blocking filtering should be applied to the block with regard to the relevant boundary. This means that the method ends or returns to step S1 where a next block of multiple pixels in the video frame is processed, which is schematically illustrated by the line L2.

If the block-specific filter decision value is below the block-specific threshold as determined in step S2, de-blocking filtering should be applied to the block and the relevant boundary. The method then continues to step S3. Step S3 forms, together with steps S4-S6, a loop that is performed for each line of pixels in the block, i.e. each row or column depending on whether the boundary is vertical or horizontal. Step S3 calculates a line-specific filter decision value for a current line in the block. The line-specific filter decision value is calculated based on at least one pixel value in the current line and at least one pixel value in the corresponding line in the neighboring block. In an embodiment, only a single pixel value in the line and a single pixel value in the corresponding line are employed in the calculation. In other embodiments, multiple, i.e. at least two, pixel values in the line and multiple pixel values in the corresponding line are employed. The at least one pixel value in the line is the pixel value of at least one pixel in predefined position(s) in the line relative the boundary. For instance, if a single pixel value is employed this could correspond to the pixel value of the pixel in the line closest to the boundary. Non-limiting examples of employing multiple pixel values include using the pixel values of the two pixels in the line closest to the boundary, of the three pixels in the line closest to the boundary or of the pixel closest to the line and of the pixel third closest to the line. The corresponding or matching positions of pixels are then employed for the corresponding line in the neighboring block.

The calculated line-specific filter decision value (LS FDV) is compared to a line-specific threshold (T_{LS}) in step S4. If the line-specific filter decision value is below the line-specific threshold the method continues to step S5, where a second or strong de-blocking filter is selected to be applied to pixels in the current line of pixels to filter and change the value of at least one pixel value in the current line. However, if the line-specific filter decision value is not below the line-specific threshold in step S4, the method instead continues to step S6, where a first, normal or weak de-blocking filter is instead selected. The weak de-blocking filter is then applicable to pixels in the current line of pixels to filter and change the value of the at least one pixel value in the current line. The strong de-blocking filter selected in step S5 has then a comparatively higher filtering strength as compared to the weak de-blocking filter selected in step S6.

The loop of steps S3 to S5/S6 is repeated for each line in the block, which is schematically illustrated by the line L1. This means that it could be possible that, for a given block, a strong de-blocking filter is selected for all lines, a weak de-blocking filter is selected for all lines or a strong de-blocking filter is selected for some of the lines whereas a weak de-blocking filter is selected for other lines in the block. The different pixel rows or pixel columns can be processed sequentially starting, for instance, with the upper row or the left-most column and then proceeding towards the bottom row or the right-most column in the block. Alternatively, the different pixel lines in the block can be processed in parallel to speed up the filtering control method.

Once all lines of the block have been processed by the loop of steps S3-S5/S6 the method ends or returns to step S1 for starting anew with another block of pixels in the video frame.

The embodiments therefore achieve a non-complex and computational efficient decision whether to apply de-blocking filtering or not for a given block and boundary. This is combined with line-specific decisions between strong and weak de-blocking filtering for those blocks where the block-specific filter decision concluded that de-blocking filtering should be applied.

Various embodiments of the filter decisions will now be described in more detail.

The block-specific filter decision value is preferably representative of how smooth pixel values in a first predefined line of pixels in the block and in a corresponding predefined first line of pixels in a neighboring block in the video frame are in a direction parallel to the filtering direction and how smooth pixel values in a second predefined line of pixels in the block and in a corresponding second predefined line of pixels in the neighboring block are in a direction parallel to the filtering direction.

The block-specific filter decision preferably, thus, represents the smoothness of the pixel values in a direction parallel to the filtering decision. In other words, the block-specific filter decision investigates whether the pixel values in the first/second predefined lines in the block and the pixel values in the corresponding predefined first/second lines of the neighboring block are smooth, i.e. vary little or at least no more than a defined maximum amount, from a direction parallel to the filtering direction over the block boundary. Such smooth pixel values will give a zero or a low block-specific filter decision value and should therefore be subject to de-blocking filtering since the pixel values are smooth with no or very little structures.

In a particular embodiment the block-specific filter decision value is calculated based on pixel values in a first predefined line 14 in the block 10 and a corresponding first predefined line 24 in the neighboring block 20 and in a second predefined line 16 in the block 10 and a corresponding second predefined line 26 in the neighboring block 10. The first and second predefined lines 14, 16 preferably correspond to predefined row numbers in the block 10 (FIG. 3A) or predefined column numbers (FIG. 3B) and the corresponding first and second predefined lines 24, 26 are the corresponding predefined row numbers or column numbers in the neighboring block 20.

The two predefined lines are preferably distributed in the block. The first filter decision value could therefore be calculated as |p2₂−2p1₂+p0₂|+q2₂−2q1₂+q0₂|+|p2₅−2p1₅+p0₅|+|q2₅−2q1₅+q0₅|. In this formula and further herein pkᵢ denotes the pixel value of a pixel at row number i and column number k in the block 10, see FIG. 3A, or the pixel value of a pixel at column number i and row number k in the block 10, see FIG. 3B. qkᵢ correspondingly denotes the pixel value of a pixel in the neighboring block 20. In the particular block embodiment illustrated in FIGS. 3A and 3B k=0, 1, 2, 3, i=0, 1, 2, 3, 4, 5, 6, 7. This means that an absolute value is calculated for row/column number two 14 and row/column number five 16 in the block 10 and for row/column number two 24 and row/column number five 26 in the neighboring block 20. Each absolute value is defined as the absolute value of the pixel value of the pixel closest to, in the relevant row/column 14, 16, 24, 26, the block boundary 1 plus the pixel value of the pixel second next closest to, in the relevant row/column 14, 16, 24, 26, the block boundary 1 subtracted by twice the pixel value of the pixel next closest to, in the relevant row/column 14, 16, 24, 26, the block boundary 1.

Alternative embodiments for calculating the block-specific filter decision value include |p2₂−2p1₃+p0₄|+q2₂−2q1₃+q0₄|+|p2₅−2p1₄+p0₃|+|q2₅−2q1₄+q0₃| or |p2₂−2p1₃+p0₄+p2₅−2p1₄+p0₃|+|q2₂−2q1₃+q0₄+q2₅−2q1₄+q0₃|. In these two embodiments, lines in the block 10 and the corresponding lines in the neighboring block 20 are diagonal lines of multiple pixels.

It is anticipated by the embodiments that in some applications more than one block-specific filter decision value is calculated per block. In such a case, de-blocking filtering will only be applied to a block and a boundary if all these block-specific filter decisions are met, i.e. when each calculated block-specific filter decision value is below its respective block-specific threshold.

A further alternative is to calculate the block-specific filter decision value based on pixel values not in two predefined lines and corresponding predefined lines as described above but rather based on pixel values in four predefined lines in the block and four corresponding predefined lines in the neighboring block:

$${\sum }_{i = 2}^{5} ( \vert p {2}_{i} - 2 p {1}_{i} + p {0}_{i} \vert + \vert q {0}_{i} - 2 q {1}_{i} + q {2}_{i} \vert ) .$$

Variants of this embodiment include using row/column number zero, three, four and seven, row/column number one, two, five and six, row/column number zero, three, five and six or row/column number one, two, four and seven. These embodiments can also be applied to only using two predefined lines and two corresponding predefined lines, such as row/column number two and five.

The filtering control method can be applied to various embodiments of calculating the line-specific filter decision value. For instance, the line-specific filter decision value can be calculated based on the pixel value of the pixel 11 closest to the boundary 1 in the line 12 of pixels 11, 13, 15, 17 and the pixel value of the pixel 21 closest to the boundary 1 in the corresponding line 22 of pixels 21, 23, 25, 27 in the neighboring block 20: |p0ᵢ−q0ᵢ|. An alternative line-specific filter decision value that can be used according to the embodiments is |p3ᵢ−p0ᵢ|+|q0ᵢ−g3ᵢ|, i.e. equal to the sum of the absolute difference between the pixel values of the pixel 11 closest to and the pixel 17 fourth closest to the boundary 1 in the line 12 and the absolute difference between the pixel values of the pixel 21 closest to and the pixel 27 fourth closest to the boundary 1 in the corresponding line 22 of the neighboring block 20. A further example of line-specific filter decision is |2p3ᵢ−p2ᵢ−2p1ᵢ+p0ᵢ|+|q0ᵢ−2q1ᵢ−q2ᵢ+2q3ᵢ.

The line-specific filter decision value calculated in step S3 could be one out of at least two line-specific filter decision values that are calculated for all lines in the block in step S3. For instance, the decision whether to apply strong de-blocking filtering or weak de-blocking filtering could be based on one, two or three different line-specific filter decision values.

A first such line-specific filter decision value could be indicative of how close pixel values in a current line of pixels approximate a flat line and how close pixel values in a corresponding current line of pixels in the neighboring block approximate a flat line. In a particular embodiment, the first line-specific filter decision is calculated as |p3ᵢ−p0ᵢ|+|q0ᵢ−g3ᵢ|. This line-specific filter decision can then be complemented by at least one further line-specific filter decision. The reason for this is that any changes to pixel values caused by strong filtering (step S5 in FIG. 2) are not bound. For instance, if at least the pixel values in the current line of the block and the pixel values in the corresponding current line of the neighboring block are fairly equal the first line-specific filter decision value will be equal to or close to zero. However, it could be possible that the pixel values in the current line, though being fairly equal, differs quite much from the pixel values in the corresponding current line. Such a situation could occur if there is a true structure or edge aligned with the block boundary. This means that the edge is not due to any blocking artifact but is an inherent property of the particular video frame and should therefore not be filtered away. It could therefore be advantageously to add a second line-specific filter decision in order to detect such edges aligned with the block boundary.

The second line-specific filter decision value is preferably representative of an absolute difference between the pixel value of the pixel closest to, in the current line, the block boundary and the pixel value of the pixel in the neighboring block closest to, in the corresponding current line, the block boundary. In other words, the second line-specific filter decision value is preferably equal to |p0ᵢ−q0ᵢ|. Step S4 then compares the first line-specific filter decision value to a first line-specific threshold and compares the second line-specific filter decision value to a second line-specific threshold. If both of the line-specific filter decision values are below their respective associated line-specific threshold the method continues to step S5 of FIG. 2, where a strong de-blocking filter is selected to be applied to pixels in the current line. Otherwise the method continues to step S6 of FIG. 2, which instead selects a weak de-blocking filter.

Embodiments also comprise using another second line-specific filter decision value that can be applied together with the first line-specific filter decision value discussed above. Alternatively, this another second line-specific filter decision value can be employed as a third line-specific filter decision value together with the above-described first and second line-specific filter decision values. This additional line-specific filter decision value is preferably representative of how smooth pixel values in at least one, preferably two, predefined lines of pixels in the block and in at least one, preferably two, corresponding predefined lines of pixels in the neighboring block are in a direction parallel to the filtering direction. In a preferred embodiment this line-specific filter decision value is calculated as |p2₂−2p1₂+p0₂|+|q2₂−2q1₂+q0₂|+|p2₅−2p1₅+p0₅|+|q2₅−2q1₅+q0₅|. This example of line-specific filter decision value is in fact equal to an embodiment of the block-specific filter decision value calculated in step S1. However, even if the filter decision values are equal the block-specific threshold employed in step S2 and the line-specific threshold employed in step S4 for this example of line-specific filter decision value are preferably different.

FIG. 4 is a flow diagram illustrating an additional step of the filtering control method. The method starts in step S10, where the block-specific threshold and the line-specific filter threshold(s) are determined based on a quantization parameter selected for the block. The quantization parameter is selected for residual coding of the block and controls the quality of video compression, which is well known in the art and therefore not further described herein.

In a particular embodiment, the block-specific threshold is determined to be T_{BS}=β, where the parameter β is determined based on the quantization parameter (QP) of the block. Table 1 below defines possible values of β for different possible quantization parameter values.

TABLE 1
Relation between QP, t_{c} and β

| | QP | | | | | | | | | | | | | |
|---|---|---|---|---|---|---|---|---|---|---|---|---|---|---|
| | 0 | 1 | 2 | 3 | 4 | 5 | 6 | 7 | 8 | 9 | 10 | 11 | 12 | 13 |
| t_{c} | 0 | 0 | 0 | 0 | 0 | 0 | 0 | 0 | 0 | 0 | 0 | 0 | 0 | 0 |
| β | 0 | 0 | 0 | 0 | 0 | 0 | 0 | 0 | 0 | 0 | 0 | 0 | 0 | 0 |
| | QP | | | | | | | | | | | | | |
| | 14 | 15 | 16 | 17 | 18 | 19 | 20 | 21 | 22 | 23 | 24 | 25 | 26 | 27 |
| t_{c} | 0 | 0 | 0 | 0 | 1 | 1 | 1 | 1 | 1 | 1 | 1 | 1 | 1 | 2 |
| β | 0 | 0 | 6 | 7 | 9 | 9 | 10 | 11 | 12 | 13 | 14 | 15 | 16 | 17 |
| | QP | | | | | | | | | | | | | |
| | 28 | 29 | 30 | 31 | 32 | 33 | 34 | 35 | 36 | 37 | 38 | 39 | 40 | 41 |
| t_{c} | 2 | 2 | 2 | 3 | 3 | 3 | 3 | 4 | 4 | 4 | 5 | 5 | 6 | 6 |
| β | 18 | 20 | 22 | 24 | 26 | 28 | 30 | 32 | 34 | 36 | 38 | 40 | 42 | 44 |
| | QP | | | | | | | | | | | | | |
| | 42 | 43 | 44 | 45 | 46 | 47 | 48 | 49 | 50 | 51 | 52 | 53 | 54 | 55 |
| t_{c} | 7 | 8 | 9 | 9 | 10 | 10 | 11 | 11 | 12 | 12 | 13 | 13 | 14 | 14 |
| β | 46 | 48 | 50 | 52 | 54 | 56 | 58 | 60 | 62 | 64 | | | | |

The particular line-specific threshold(s) determined in step S10 based on the quantization parameter depend(s) on the particular line-specific filter decision(s) employed in the filtering control method. For instance, if the line-specific filter decision value is |p3ᵢ−p0ᵢ|+|q0ᵢ−q3ᵢ|, T_{BS}=β>>3, where X>>Y denotes right shift of X by 2^{Y}, i.e. X/2^{Y}.

If the line-specific filter decision value is calculated as |p0ᵢ−q0ᵢ| the line-specific threshold is preferably defined as T_{BS}=a₁×t_{C}. The parameter t_{C} represents a clipping threshold selected for the block based on the quantization parameter according to Table 1 above. The parameter aₗ is a multiplier selected to prevent selecting the strong de-blocking filter if strong filtering with the strong de-blocking filter modifies the pixel value of the pixel closest to, in the current line, the block boundary with a value that is larger than a value which weak filtering with the weak de-blocking filter and the clipping threshold will modify the pixel value. Experimental tests have been conducted and verify that a₁=2.5 performs well. Additionally, a value of 2.5 implies that the line-specific threshold can be calculated without any divisions as T_{BS}=(t_{C}×5+1)>>1. If the line-specific filter decision value is calculated as |p2₂−2p1₂+p0₂|+|q2₂−2q1₂+q0₂|+|p2₅−2p1₅+p0₅|+|q2₅−2q1₅+q0₅|, the line-specific threshold is preferably T_{BS}=β>>2.

Hence, a single look-up table, such as Table 1, can be used to derive all the threshold values employed for block-specific of line-specific threshold for the embodiments presented above.

In an embodiment, additional conditions or criteria can be used in addition to the block-specific filter decision in order to decide whether a block boundary between a current block A and a neighboring block B should be filtered. Examples of such additional conditions include:
i) block A or block B has prediction mode (PredMode) equal to intra (MODE_INTRA);
ii) block A or block B has nonzero transform coefficients;
iii) block A or block B use different reference frames or different number of motion vectors;
iv) one motion vector is used to predict block A and one motion vector is used to predict block B and the absolute difference between the horizontal or vertical component of the motion vectors used is greater than or equal to four in units of quarter luma frame samples;
v) two motion vectors and two different reference pictures are used to predict block A and two motion vectors for the same two reference pictures are used to predict block B and the absolute difference between the horizontal or vertical component of the two motion vectors used in the prediction of the two blocks for the same reference picture is greater than or equal to four in units of quarter luma frame samples;
vi) two motion vectors for the same reference picture are used to predict block A and two motion vectors for the same reference picture are used to predict block B and the absolute difference between the horizontal or vertical component of the corresponding motion vectors used in the prediction of the two partitions is greater than or equal to four in units of quarter luma frame samples.

The above presented conditions i) to vi) are preferably alternatives. This means that if any of the conditions i) to vi) are met for a current block A and if the block-specific filter decision is true, de-blocking filtering should be applied over the block boundary and a strong or weak de-blocking filter should be selected for each line of pixels in the block. This also implies that if none of the conditions i) to vi) are met for a current block A, no de-blocking filtering is preferably conducted for block A and the relevant boundary.

FIG. 5 is a flow diagram illustrating an additional step of the method illustrated in FIG. 2. The method continues from step S5 or S6 in FIG. 2. A next step S20 filters pixel values in the current lines of pixels with the selected de-blocking filter. This means that if the method continues from step S5 in FIG. 2, step S20 filters the pixel values with a strong de-blocking filter.

The embodiments can be applied in connection with any strong de-blocking filter employed in the art to combat blocking artifacts. In a particular embodiment, the strong de-blocking filtering is performed with the following set of operations:

p0ᵢ′=(p2ᵢ+2p1ᵢ+2p0ᵢ+2q0ᵢ+q1ᵢ+4)>>3

p1ᵢ′=(p2ᵢ+p1ᵢ+p0ᵢ+q0ᵢ+2)>>2

p2ᵢ=(2p3ᵢ+3p2ᵢ+p1ᵢ+p0ᵢ+q0ᵢ+4)>>3

q0ᵢ′=(p1ᵢ+2p0ᵢ+2q0ᵢ+2q1+q2ᵢ+4)>>3

p1ᵢ′=(p0ᵢ++q0ᵢ+q1ᵢ+q2ᵢ+2)>>2

q2ᵢ′=(p0ᵢ+q0ᵢ+q1ᵢ+3q2ᵢ+2q3ᵢ+4)>>3

where i represents the current line in the block. Hence, with reference to the blocks in FIGS. 3A and 3B i=0, . . . , 7. In the equations above pkᵢ′qkᵢ′, k=0 . . . 2, represent the modified pixel values in the block and the neighboring block respectively, after filtering.

The modified pixel values are preferably also clipped to be forced to be within an allowed pixel value range. In a particular embodiment, the clipping operation forces the modified pixel values to be present within the range of [0, 255], allowing 256 different pixel values. This means that if the modified pixel value after filtering is smaller than 0 or larger than 255 it is replaced by 0 or 255, respectively.

If the comparison in step S4 of FIG. 2 instead results in that the method continues to step S6 of FIG. 2, step S20 filters the pixel values with a weak de-blocking filter.

The embodiments can be applied in connection with any weak de-blocking filter employed in the art to combat blocking artifacts. In a particular embodiment, the weak de-blocking filtering is performed with the following set of operations:

p0ᵢ′=p0ᵢ+Δ₀

q0ᵢ′=q0ᵢ−Δ₀

The value Δ₀ is calculated in a two-step process with the calculation of an initial Δ₀i value, followed by clipping of this value before it is applied to the equations above. In a particular embodiment, Δ₀i=(p1ᵢ−4p0ᵢ+4q0ᵢ−qᵢ+4)>>3. The impulse response of the weak de-blocking filter is (1, 4, 4−1)/8. The clipping range of Δ₀i is determined based on the quantization parameter of the block.

In this embodiment, the values p1ᵢ, q1ᵢ are modified if additional filter conditions are met otherwise the pixel values are not modified. In an embodiment, p1ᵢ is modified if |p2ᵢ−p0ᵢ|<T, where T represents a threshold and is preferably determined based on the quantization parameter of the block. If this condition is true, p1ᵢ′=p1ᵢ+Δₚ₁. The value Δₚ₁ is also calculated in a two-step process starting with calculating an initial value Δₚ₁ᵢ=(p2ᵢ+((p0ᵢ+q0ᵢ+1)>>1)−2p1ᵢ)>>1. The corresponding impulse response is (1, 0, 0.5, 0.5)/2. Δₚ₁ is then determined as Δₚ₁=Min(Max(−t_{C},Δₚ₁),t_{C}), where t_{C} is determined based on the quantization parameter of the block and could be determined from a look-up table, such as Table 1 above.

Correspondingly, q1ᵢ is modified if |q2ᵢ−q0ᵢ|<T. If this condition is true, q1ᵢ′=q1ᵢ+Δ_{q1}. The value Δ_{q1} is also calculated in a two-step process starting with calculating an initial value Δ_{q1i}=(q2ᵢ+((q0ᵢ+p0ᵢ+1)>>1)−2q1ᵢ)>>1 with impulse response (0.5, 0.5, 0, 1)/2. Δ_{q1} is then determined as Δ_{q1}=Min(Max(−t_{C},Δ_{q1i}),t_{C}).

In an embodiment, the clipping range for Δ₀i is determined based on the value t_{C} and the evaluation of the conditions |p2ᵢ−p0ᵢ|<T and |q2ᵢ−q0ᵢ|<T. In such a case, a clipping value t_{C}′ is first set equal to t_{C} and is then incremented by one for each of the conditions |p2ᵢ−p0ᵢ|<T and |q2ᵢ−q0ᵢ|<T that are met. In an embodiment, Δ₀=Min(Max(−t_{C}′,Δ₀ᵢ),t_{C}′).

In an alternative embodiment, Δₚ₁ᵢ=((((((p0ᵢ+q0ᵢ+1)>>1)+p2ᵢ+1)>>1)−p1ᵢ)>>1 and Δ_{q1i}=(((((p0ᵢ+q0ᵢ+1)>>1)+q2ᵢ+1)>>1)−q1ᵢ)>>1. The impulse responses are (2, 4, 1, 1)/8 and (1, 1, 4, 2)/8. This filtering provides better interpolation properties for the pixel values p2ᵢ,q2ᵢ compared to using a filter with filter taps (1, 0, 0.5, 0.5)/2. This also reduces the risk of unintentionally introducing artificial edges.

In another embodiment, the weak filtering is performed according to the following operations:

Δ=Clip(−t_{C},t_{C},(13(q0ᵢ−p0ᵢ)+4(q1ᵢ−p1ᵢ)−5(q2ᵢ−p2ᵢ)>>5))

p0ᵢ′=Clip(0,255,(p0ᵢ+Δ))

q0ᵢ′=Clip(0,255,(q0ᵢ+Δ))

p1ᵢ′=Clip(0,255,(p1ᵢ+Δ/2))

q1ᵢ′=Clip(0,255,(q1ᵢ−Δ/2))

where Clip(a, b, X)=Min(Max(a,X),b).

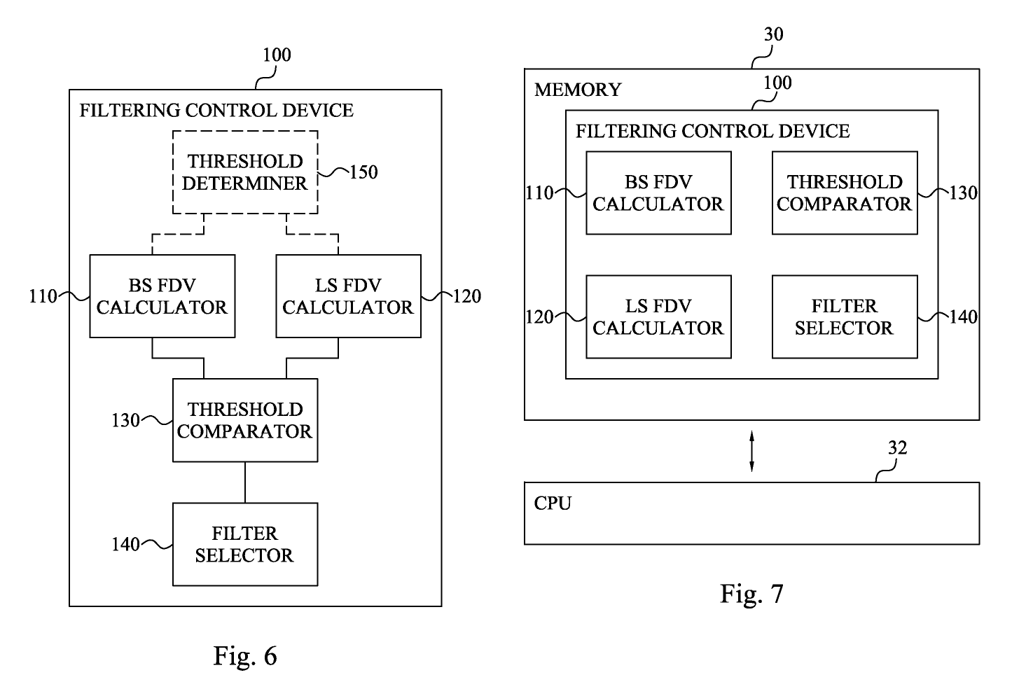

FIG. 6 is a schematic block diagram of a filtering control device 100 according to an embodiment. The filtering control device 100 comprises a block-specific filter decision value calculator 110 configured to calculate a block-specific filter decision value for a block of multiple pixels in a video frame. The block-specific filter decision value calculator 110 calculates the block-specific filter decision value based on pixel values in a predefined subset of the lines of pixels in the block and based on pixel values in a predefined corresponding subset of the corresponding lines of pixels in a neighboring block of multiple pixels in the video frame. In an embodiment, the block-specific filter decision value calculator 110 calculates a block-specific filter decision value that is representative of how smooth pixel values in a first predefined line of pixels in the block and in a corresponding first predefined line of pixels in the neighboring block are in a direction parallel to a filtering direction and how smooth pixel values in a second predefined line of pixels in the block and in a corresponding second predefined line of pixels in the neighboring block are in a direction parallel to the filtering direction, such as |p2₂−2p1₂+p0₂|+|q2₂−2q1₂+q0₂|+|p2₅−2p1₅+p0₅|+|q2₅−2q1₅+q0₅|.

A threshold comparator 130 is configured to compare the block-specific filter decision value calculated by the block-specific filter decision value calculator 110 with a block-specific threshold.

If the block-specific filter decision value is below the block specific threshold as determined by the threshold comparator 130 a line-specific filter decision value calculator 120 of the filtering control device 100 calculates a respective line-specific filter decision value for each line of pixels in the block. The line-specific filter decision value is calculated based on at least one pixel value in the line in the block and at least one pixel value in a corresponding line in the neighboring block. The line-specific filter decision value calculator 120 can calculate the line-specific filter decision values according any of the previously described embodiments. The line-specific filter decision value calculator 120 could also calculate two or more, such as three, different line-specific filter decision values for each line as disclosed herein.

The line-specific filter decision values calculated by the line-specific filter decision value calculator 120 are compared to a line-specific threshold by the threshold comparator 130. If the line-specific filter decision value calculator 120 calculates multiple different line-specific filter decision values per line, the threshold comparator 130 uses different line-specific thresholds for the different line-specific filter decision values as described in the foregoing.

The filtering control device 100 additionally comprises a filter selector 140 configured to select a de-blocking filter to filter at least one pixel value in the current line of pixels if block-specific filter decision value is below the block-specific threshold as determined by the threshold comparator 130. The filter selector 140 then selects de-blocking filter between a strong de-blocking filter and a weak de-blocking filter based on the comparison between the line-specific filter decision value(s) for the current line and the line-specific threshold(s). Thus, if the line-specific filter decision value(s) is(are) below its(their) associated line-specific threshold, the filter selector 140 selects a strong de-blocking filter for the current line. Otherwise the filter selector 140 is configured to select a weak de-blocking filter to filter at least one pixel value in the current line of pixels.

In an optional embodiment, the filtering control device 100 comprises a threshold determiner 150 configured to determine the block-specific and line-specific thresholds. In a particular embodiment, the threshold determiner 150 determines the thresholds for the block based on the quantization parameter selected for residual coding of the block. The threshold determiner 150 then advantageously determines the thresholds as discussed above in connection with Table 1.

The filtering control device 100 could be implemented at least partly in software. FIG. 7 is a schematic block diagram of the filtering control device 100 implemented as a computer program product stored on a memory 30 and loaded and run on a general purpose or specially adapted computer, processor or microprocessor, represented by a central processing unit (CPU) 32 in the figure.

The software includes computer program code elements or software code portions effectuating the operation of at least the block-specific filter decision value calculator 110, the line-specific filter decision value calculator 120, the threshold comparator 130, the filter selector 140 and the optional threshold determiner. The program may be stored in whole or part, on or in one or more suitable volatile computer readable media or data storage means, such as RAM, or one or more non-volatile computer readable media or data storage means, such as magnetic disks, CD-ROMs, DVD disks, hard discs, in ROM or flash memory. The data storage means can be a local data storage means or is remotely provided, such as in a data server. The software may thus be loaded into the operating memory of a computer or equivalent processing system for execution by a processor. The computer/processor does not have to be dedicated to only execute the above-described functions but may also execute other software tasks. A non-limiting example of program code used to define the filtering control device 100 include single instruction multiple data (SIMD) code.

Alternatively the filtering control device can be implemented in hardware. There are numerous variants of circuitry elements that can be used and combined to achieve the functions of the units of the filtering control device. Such variants are encompassed by the embodiments. Particular examples of hardware implementation of the filtering control device is implementation in digital signal processor (DSP) hardware and integrated circuit technology, including both general-purpose electronic circuitry and application-specific circuitry.

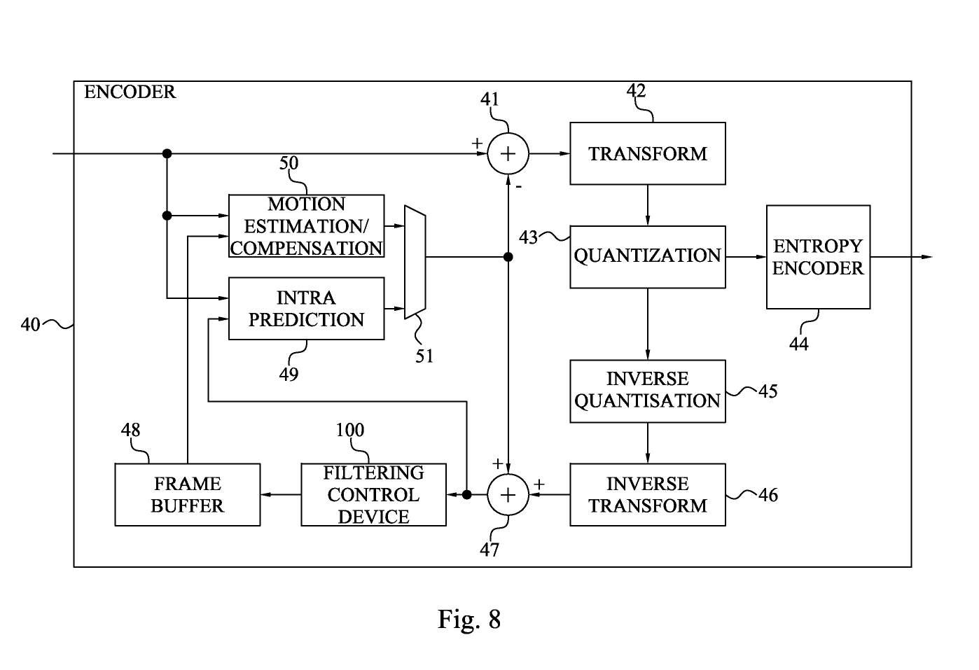

FIG. 8 is a schematic block diagram of an encoder 40 for encoding a block of pixels in a video frame of a video sequence according to an embodiment.

A current block of pixels is predicted by performing motion estimation by a motion estimator 50 from an already provided block of pixels in the same frame or in a previous frame. The result of the motion estimation is a motion or displacement vector associated with the reference block, in the case of inter prediction. The motion vector is utilized by a motion compensator 50 for outputting an inter prediction of the block of pixels.

An intra predictor 49 computes an intra prediction of the current block of pixels. The outputs from the motion estimator/compensator 50 and the intra predictor 49 are input in a selector 51 that either selects intra prediction or inter prediction for the current block of pixels. The output from the selector 51 is input to an error calculator in the form of an adder 41 that also receives the pixel values of the current block of pixels. The adder 41 calculates and outputs a residual error as the difference in pixel values between the block of pixels and its prediction.

The error is transformed in a transformer 42, such as by a discrete cosine transform, and quantized by a quantizer 43 followed by coding in an encoder 44, such as by entropy encoder. In inter coding, also the estimated motion vector is brought to the encoder 44 for generating the coded representation of the current block of pixels.

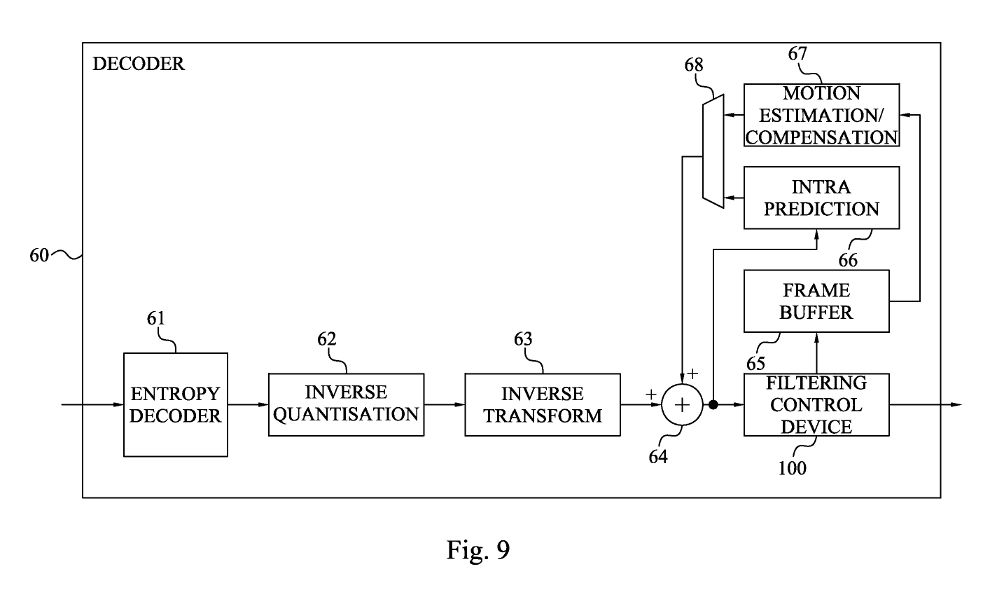

The transformed and quantized residual error for the current block of pixels is also provided to an inverse quantizer 45 and inverse transformer 46 to retrieve the original residual error. This error is added by an adder 47 to the block prediction output from the motion compensator 50 or the intra predictor 49 to create a reference block of pixels that can be used in the prediction and coding of a next block of pixels. This new reference block is first processed by a filtering control device 100 according to the embodiments in order to determine whether de-blocking filtering will be applied and in such a case what type of de-blocking filter to use. The processed new reference block is then temporarily stored in a frame buffer 48, where it is available to the intra predictor 49 and the motion estimator/compensator 50. FIG. 9 is a corresponding schematic block diagram of a decoder 60 comprising a filtering control device 100 according to the embodiments. The decoder 60 comprises a decoder 61, such as entropy decoder, for decoding an encoded representation of a block of pixels to get a set of quantized and transformed residual errors. These residual errors are dequantized in an inverse quantizer 62 and inverse transformed by an inverse transformer 63 to get a set of residual errors.

These residual errors are added in an adder 64 to the pixel values of a reference block of pixels. The reference block is determined by a motion estimator/compensator 67 or intra predictor 66, depending on whether inter or intra prediction is performed. A selector 68 is thereby interconnected to the adder 64 and the motion estimator/compensator 67 and the intra predictor 66. The resulting decoded block of pixels output form the adder 64 is input to a filtering control device 100 according to the embodiments in order to de-blocking filter any blocking artifacts. The filtered block of pixels is output form the decoder 60 and is furthermore preferably temporarily provided to a frame buffer 65 and can be used as a reference block of pixels for a subsequent block of pixels to be decoded. The frame buffer 65 is thereby connected to the motion estimator/compensator 67 to make the stored blocks of pixels available to the motion estimator/compensator 67.

The output from the adder 64 is preferably also input to the intra predictor 66 to be used as an unfiltered reference block of pixels.

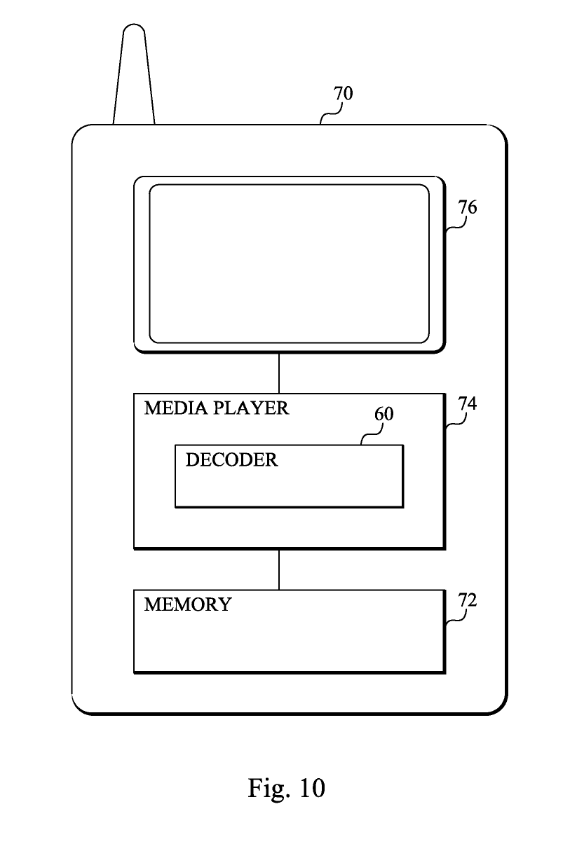

FIG. 10 is a schematic block diagram of a media terminal 70 housing a decoder 60 with a filtering control device. The media terminal 70 can be any device having media decoding functions that operates on an encoded video stream of encoded video frames to thereby decode the video frames and make the video data available. Non-limiting examples of such devices include mobile telephones and other portable media players, computers, decoders, game consoles, etc. The media terminal 70 comprises a memory 72 configured to store encoded video frames. These encoded video frames can have been generated by the media terminal 70 itself. In such a case, the media terminal 70 preferably comprises a media engine or recorder together with a connected encoder, such as the encoder of FIG. 8. Alternatively, the encoded video frames are generated by some other device and wirelessly transmitted or transmitted by wire to the media terminal 70. The media terminal 70 then comprises a transceiver (transmitter and receiver) or input and output port to achieve the data transfer.

The encoded video frames are brought from the memory 72 to a decoder 60, such as the decoder illustrated in FIG. 9. The decoder 60 then decodes the encoded video frames into decoded video frames. The decoded video frames are provided to a media player 74 that is configured to render the decoded video frames into video data that is displayable on a display or screen 76 of or connected to the media terminal 70.

In FIG. 10, the media terminal has been illustrated as comprising both the decoder 60 and the media player 74, with the decoder 60 implemented as a part of the media player 74. This should, however, merely be seen as an illustrative but non-limiting example of an implementation embodiment for the media terminal 70. Also distributed implementations are possible where the decoder 60 and the media player 74 are provided in two physically separated devices are possible and within the scope of media terminal 70 as used herein. The display 76 could also be provided as a separate device connected to the media terminal 70, where the actual data processing is taking place.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1-11. (canceled)

12. A filtering control method applicable to a block of multiple pixels in a video frame, each pixel having a respective pixel value, said method comprising:
calculating a block-specific filter decision value for said block based on pixel values in a predefined subset of the lines of pixels in said block and pixel values in a corresponding predefined subset of corresponding lines of pixels in said neighboring block;
calculating, if said block-specific filter decision value is below a block-specific threshold and for each line of pixels in said block, a line-specific filter decision value based on at least one pixel value in said line and at least one pixel value in a corresponding line of pixels in said neighboring block;
comparing, if said block-specific filter decision value is below said block-specific threshold and for each line of pixels in said block, said line-specific filter decision value with a line-specific threshold; and
selecting, if said block-specific filter decision value is below said block-specific threshold and for each line of pixels in said block, a strong de-blocking filter to filter at least one pixel value in said line if said line-specific filter decision value is below said line-specific threshold and otherwise selecting a weak de-blocking filter to filter at least one pixel value in said line, wherein said strong de-blocking filter has a comparatively higher filtering strength as compared to said weak de-blocking filter.

13. The method according to claim 1, wherein calculating said block-specific filter decision value comprises calculating said block-specific filter decision value representative of how smooth pixel values in a first predefined line of pixels in said block and in a corresponding first predefined line of pixels in said neighboring block are in a direction parallel to a filtering direction and how smooth pixel values in a second predefined line of pixels in said block and in a corresponding second predefined line of pixels in said neighboring block are in a direction parallel to said filtering direction.

14. The method according to claim 2, wherein calculating said block-specific filter decision value comprises calculating said block-specific filter decision value as

|p2₂−2p1₂+p0₂|+|q2₂−2q1₂+q0₂|+|p2₅−2p1₅+p0₅|+|q2₅−2q1₅+q0₅|

where p0₂ denotes a pixel value of a pixel closest to, in said first predefined line, a block boundary to said neighboring block, p1₂ denotes a pixel value of a pixel next closest to, in said first predefined line, said block boundary, p2₂ denotes a pixel value of a pixel second next closest to, in said predefined first line, said block boundary, q0₂ denotes a pixel value of a pixel in said neighboring block closest to, in said corresponding first predefined line, said block boundary, q1ⱼ denotes a pixel value of a pixel of said neighboring block next closest to, in said corresponding first predefined line, said block boundary, q2₂ denotes a pixel value of a pixel in said neighboring block second next closest to, in said corresponding first predefined line, said block boundary, p0₅ denotes a pixel value of a pixel closest to, in said second predefined line, said block boundary, p1₅ denotes a pixel value of a pixel next closest to, in said second predefined line, said block boundary, p2₅ denotes a pixel value of a pixel second next closest to, in said second predefined line, said block boundary, q0₅ denotes a pixel value of a pixel in said neighboring block closest to, in said corresponding second predefined line, said block boundary, q1₅ denotes a pixel value of a pixel of said neighboring block next closest to, in said corresponding second predefined line, said block boundary and q2₅ denotes a pixel value of a pixel in said neighboring block second next closest to, in said corresponding predefined second line, said block boundary.

15. The method according to any of claim 1, further comprising determining said block-specific threshold and said line-specific threshold based on a quantization parameter selected for residual coding of said block.

16. A filtering control device comprising:
a block-specific filter decision value calculator configured to calculate a block-specific filter decision value for a block of multiple pixels in a video frame, each pixel having a respective pixel value, based on pixel values in a predefined subset of the lines of pixels in said block and pixel values in a corresponding predefined subset of corresponding lines of pixels in a neighboring block of multiple pixels in said video frame;
a line-specific filter decision value calculator configured to calculate, if said block-specific filter decision value calculated by said block-specific filter decision value calculator is below a block-specific threshold and for each line of pixels in said block, a line-specific filter decision value based on at least one pixel value in said line and at least one pixel value in a corresponding line of pixels in said neighboring block;
a threshold comparator configured to compare, if said block-specific filter decision value calculated by said block-specific filter decision value calculator is below said block-specific threshold and for each line of pixels in said block, said line-specific filter decision value calculated by said line-specific filter decision value calculator with a line-specific threshold; and
a filter selector configured to select, if said block-specific filter decision value is below said block-specific threshold and for each line of pixels in said block, a strong de-blocking filter to filter at least one pixel value in said line if said line-specific filter decision value is below said line-specific threshold as determined by said threshold comparator and otherwise select a weak de-blocking filter to filter at least one pixel value in said line, wherein said strong de-blocking filter has a comparatively higher filtering strength as compare to said weak de-blocking filter.

17. The device according to claim 5, wherein said block-specific filter decision value calculator is configured to calculate said block-specific filter decision value representative of how smooth pixel values in a first predefined line of pixels in said block and in a corresponding first predefined line of pixels in said neighboring block are in a direction parallel to a filtering direction and how smooth pixel values in a second predefined line of pixels in said block and in a corresponding second predefined line of pixels in said neighboring block are in a direction parallel to said filtering direction;

18. The device according to claim 6, wherein said block-specific filter decision value calculator is configured to calculate said block-specific filter decision value as

|p2₂−2p1₂+p0₂|+|q2₂−2q1₂+q0₂|+|p2₅−2p1₅+p0₅|+|q2₅−2q1₅+q0₅|

where p0₂ denotes a pixel value of a pixel closest to, in said first predefined line, a block boundary to said neighboring block, p1₂ denotes a pixel value of a pixel next closest to, in said first predefined line, said block boundary, p2₂ denotes a pixel value of a pixel second next closest to, in said predefined first line, said block boundary, q0₂ denotes a pixel value of a pixel in said neighboring block closest to, in said corresponding first predefined line, said block boundary, q1ⱼ denotes a pixel value of a pixel of said neighboring block next closest to, in said corresponding first predefined line, said block boundary, q2₂ denotes a pixel value of a pixel in said neighboring block second next closest to, in said corresponding first predefined line, said block boundary, p0₅ denotes a pixel value of a pixel closest to, in said second predefined line, said block boundary, p1₅ denotes a pixel value of a pixel next closes to, in said second predefined line, said block boundary, p2₅ denotes a pixel value of a pixel second next closest to, in said second predefined line, said block boundary, q0₅ denotes a pixel value of a pixel in said neighboring block closest to, in said corresponding second predefined line, said block boundary q1₅ denotes a pixel value of a pixel of said neighboring block next closest to, in said corresponding second predefined line, said block boundary and q2₅ denotes a pixel value of a pixel in said neighboring block second next closest to, in said corresponding predefined second line, said block boundary.

19. The device according to claim 5, further comprising a threshold determiner configured to determine said block-specific threshold and said line-specific threshold based on a quantization parameter selected for residual coding of said block.

20. An encoder configured to encode video frames into encoded video frames, said encoder comprising a filtering control device, said filtering control device configured to:
calculate a block-specific filter decision value for said block based on pixel values in a predefined subset of the lines of pixels in said block and pixel values in a corresponding predefined subset of corresponding lines of pixels in said neighboring block;
calculate, if said block-specific filter decision value is below a block-specific threshold and for each line of pixels in said block, a line-specific filter decision value based on at least one pixel value in said line and at least one pixel value in a corresponding line of pixels in said neighboring block;
compare, if said block-specific filter decision value is below said block-specific threshold and for each line of pixels in said block, said line-specific filter decision value with a line-specific threshold; and
select, if said block-specific filter decision value is below said block-specific threshold and for each line of pixels in said block, a strong de-blocking filter to filter at least one pixel value in said line if said line-specific filter decision value is below said line-specific threshold and otherwise selecting a weak de-blocking filter to filter at least one pixel value in said line, wherein said strong de-blocking filter has a comparatively higher filtering strength as compared to said weak de-blocking filter.

21. A decoder to decode encoded video frames into decoded video frames, said decoder comprising a filtering control device, said filtering control device configured to:
calculate a block-specific filter decision value for said block based on pixel values in a predefined subset of the lines of pixels in said block and pixel values in a corresponding predefined subset of corresponding lines of pixels in said neighboring block;
calculate, if said block-specific filter decision value is below a block-specific threshold and for each line of pixels in said block, a line-specific filter decision value based on at least one pixel value in said line and at least one pixel value in a corresponding line of pixels in said neighboring block;
compare, if said block-specific filter decision value is below said block-specific threshold and for each line of pixels in said block, said line-specific filter decision value with a line-specific threshold; and
select, if said block-specific filter decision value is below said block-specific threshold and for each line of pixels in said block, a strong de-blocking filter to filter at least one pixel value in said line if said line-specific filter decision value is below said line-specific threshold and otherwise selecting a weak de-blocking filter to filter at least one pixel value in said line, wherein said strong de-blocking filter has a comparatively higher filtering strength as compared to said weak de-blocking filter.

22. A media terminal comprising:
a memory configured to store encoded video frames;
a decoder configured to decode said encoded video frames into decoded video frames, said decoder comprising a filter control circuit configured to:
calculate a block-specific filter decision value for said block based on pixel values in a predefined subset of the lines of pixels in said block and pixel values in a corresponding predefined subset of corresponding lines of pixels in said neighboring block;
calculate, if said block-specific filter decision value is below a block-specific threshold and for each line of pixels in said block, a line-specific filter decision value based on at least one pixel value in said line and at least one pixel value in a corresponding line of pixels in said neighboring block;
compare, if said block-specific filter decision value is below said block-specific threshold and for each line of pixels in said block, said line-specific filter decision value with a line-specific threshold; and
select, if said block-specific filter decision value is below said block-specific threshold and for each line of pixels in said block, a strong de-blocking filter to filter at least one pixel value in said line if said line-specific filter decision value is below said line-specific threshold and otherwise selecting a weak de-blocking filter to filter at least one pixel value in said line, wherein said strong de-blocking filter has a comparatively higher filtering strength as compared to said weak de-blocking filter; and
a media player configured to render said decoded video frames into video data displayable on a display.
